(19) United States
(12) Patent Application Publication
(10) Pub. No.: US 2018/0330451 A1
(43) Pub. Date: Nov. 15, 2018

(54) Payment System and Method Including Account Reconciliation with Float

(71) Applicant: Instant Financial, Inc., Vancouver (CA)

(72) Inventors: Ryan Volberg, Port Moody (CA); Kevin Bernhard Falk, Montreal (CA); Steve Barha, Burnaby (CA)

(21) Appl. No.: 15/977,303

(22) Filed: May 11, 2018

Related U.S. Application Data
(60) Provisional application No. 62/505,508, filed on May 12, 2017.

(51) Int. Cl. G06Q 40/00; G06Q 10/10

(52) U.S. Cl. CPC G06Q 40/125; G06Q 10/1091

(57) ABSTRACT

Systems, methods, and devices for paying a worker (employee, contractor, etc.) soon after that worker's shift. An application on an employee's mobile computing device allows that worker to receive offers to receive their pay based on employer provided shift or pay details, details of their rate of pay in a database or to declare the duration of a shift worked. Once the shift is over, a first server calculates the worker's pay for that shift or pay based on data from a first database and on data regarding the shift or pay details. A portion of the worker's pay for the shift is then transferred to an account that the worker has and which is tracked by a second server in communication with a second database.

### CLAIM OF PRIORITY

The present application claims priority to U.S. Provisional Patent Application No. 62/505,508, filed May 12, 2017, and entitled “Payment System and Method Including Account Reconciliation with Float Account”, the disclosure of which is incorporated herein by reference thereto.

### TECHNICAL FIELD

The present invention relates to payment systems. More specifically, the present invention relates to payment systems which allow for workers (such as employees, contractors, etc.) to get paid at least a portion of their earnings immediately or shortly after their work day.

### BACKGROUND OF THE INVENTION

The concept of shift work and paying employees based on the amount of time spent working is quite old. This concept, in which employees are paid a set amount of money for every hour (or portion thereof) spent working at an employee's premises or location, is currently the payment model of choice for businesses which use rotating shifts of employees. As such, factories, food service businesses (e.g. restaurants), retail outlets, and other shift-based businesses use this model. While the model works for the employers, one drawback is for the employee as employees generally do not get paid at the end of their shift. Currently, most shift-based businesses pay their employees on a weekly, bi-weekly, or even monthly schedule. The present art of paying employees is anchored by a 1:1 linkage between processing payroll and remitting payment to employees. For example, if an employer wants to pay its employees bi-weekly they need to process payroll bi-weekly. To pay employees weekly, payroll must be processed weekly. Unfortunately, increasingly employees require the funds he or she has earned in a shift well before the employer's scheduled pay disbursement. Which is to say that there is a fracture between when employers process payroll and when their employees need access to earned pay. These two things are increasingly misaligned. To this end, employees may need to avail themselves of services offered by payday loans, payroll advances, overdraft accounts or other short-term lenders. Such services, while useful, may charge high interest rates and/or fees to the employees which could lead to a never-ending cycle of debt for the employees.

While it might be possible for employers to pay an employee soon after that employee's shift, this type of approach is difficult for employers to implement as, in most cases, these employers already have set payment systems, schedules, and procedures in place. As well, it should be noted that these same employers may have employees that are not shift workers and who are not paid using a shift work model. These other employees may not require or even desire to be paid soon after they have finished their work.

Another challenge to paying employees immediately after their shift is the lack of systems that can move money to an employee quickly. Most businesses pay employees by a variety of methods that include checks, direct deposit to a bank account or via a pre-paid credit or debit card (e.g. a pay card). All of these methods involve a considerable amount of latency between when the employer sends the funds and when the employee receives the funds. It is therefore necessary to have a system that can move money between an employer and an employee in real-time.

Finally, current systems do not have any means for tracking the employee during that employee's shift. Punch clocks are often used to determine when an employee arrives and leaves an employer's premises but these outdated systems have no means to determine if the employee stays within the employer's premises during the whole shift. Moreover, existing punch clock systems may have technological limitations that prevent them from being able to share the punch data in a timely and reliable manner.

There is therefore a need for systems, methods, and devices which mitigate if not overcome the shortcomings of the prior art. Preferably, such solutions can allow employees to get paid at least a portion of their earnings soon after the end of their shift based on the data being collected by punch clock systems or other means while also allowing employers to track the employee's location during that employee's shift, if desired.

### SUMMARY OF INVENTION

The present invention relates to worker (e.g., employee, contractor) payment systems. As used herein, “employee” may refer to any type of worker—employee, contractor, etc. For ease of reference, “employee” is used throughout this specification to denote any type of worker paid during a work period. More specifically, the present invention relates to systems, methods, and devices for paying an employee soon after that employee's shift. An application on an employee's mobile computing device allows for an employee to receive payment offers using shift details which may be generated by a punch clock system or be based on other data that an employer uses to determine a worker's pay or a score generated by a machine learning system, neural network, or similar system which takes numerous real-time and historical data points into account and that may also include the employee's location. The application may also access the mobile device's GPS functions so that for the duration of the employee's shift it would allow for continuous tracking of the employee's location to ensure that the employee has stayed within the location(s) where the work is to take place. The application may continuously notify a first server as to the employee's whereabouts during the employee's shift. Once the shift is over as evidenced for example, by an employee having clocked-in and then out on the employer's punch clock system or the employee having declared their hours worked using the application, the application may notify the first server of the shift details. In the absence of either punch clock data or a shift declaration, geolocation information may be used by a machine learning, neural network, or similar system in combination with other real-time and historical data points to enable the generation of a pay offer. At this point, the first server calculates the employee's pay for that shift based on data on a first database and an offer to receive pay for that particular shift is presented to the employee via the application. If the employee selects to accept the pay or has configured the application to automatically accept this pay, a portion of the employee's pay for the shift is then transferred to the account that the employee has created and which is tracked by a second server in communication with a second database.

Offers to receive pay and the calculation of the amount available may include a variety of properties to ensure employees' financial interests are protected and ensure employers are not exposed to the risk of overpaying employees.
Pay offers provide optional access to wages. It is the employee's choice to access their pay for the shift or not which places the employee in control of the flow and timing of their pay and also minimizes demands on employer's cash flow.
Pay offers may be perishable, depending on the configuration of a location, thereby expiring within a set number of hours of being made. This insulates employees from being able to act impulsively by preventing access to numerous days of their wages all at once prior to payday.
By providing access to only a percentage of the gross wage, the offer ensures sufficient funds are available on payday to cover deductions.
To safeguard employers from overpaying employees in the event of bad data or attempts at fraud, pay offers may be constrained in a number of ways. These constraints may include, for example: a cap on the maximum dollar amount, a cap on the hours available for use in the pay offer calculation, and rules that determine what is deemed a valid time punch record for the purpose of generating a pay offer. For example, any time punch record that has been created by the system automatically may be deemed ineligible for the generation of a pay offer.

To enable the real-time movement of money between the employer and the employee, the pay is transferred to an employee from a float system that contains or has access to funds which are used to satisfy pay requests. In one embodiment, the float system is a bank account held by the employer that shares a common financial platform to the application, financial devices and their related accounts and therefore is able to satisfy employee pay requests in real-time. The employee is issued with a financial device (e.g. a prepaid card) that is tied to the employee's account and managed though an employee application that gives the employee access to the balance of the employee's account. The funds in the employee's account can then be spent, transferred, or otherwise used by using the financial device or via functionality present in the employee application. The rest of the employee's pay is disbursed on the next regular pay period.

The float system enables the real-time movement of funds to employees and the ability to reconcile real-time pay amounts with the employee's final pay for the period after the normal payroll process has been completed, thereby avoiding disruption to an employer's existing payroll process. Note that the existing payroll process remains the system of record for an employee's pay. Wages drawn by the employee in the period are deducted from the final calculated net pay amount.

The payment process described herein is a means by which employers can provide employees with on-demand access to their earned income on or close to the day it was earned, before payday.

This payment process, in embodiments, fractures the relationship between payday and the earning of income. It enables employers to pay employees daily and on-demand without changing payroll processing cadence.

### BRIEF DESCRIPTION OF THE DRAWINGS

The embodiments of the present invention will now be described by reference to the following figures, in which identical reference numerals in different figures indicate identical elements and in which:

FIG. 1A is a block diagram of a system according to one aspect of the invention;

FIG. 1B illustrates a flow chart of a system according to an embodiment of the invention;

FIG. 1C illustrates a flow chart of a system according to an embodiment of the invention;

FIG. 1D illustrates the relationships and flow of data between the invention, the employer's existing business systems, and the employee via the employee application.

FIG. 1E illustrates a process performed according to the teachings of the present invention, in one embodiment.

FIG. 2 is a screenshot of a main screen for an employee's wireless mobile device;

FIG. 3 is a screenshot detailing an employee's pay and/or payments from employers;

FIG. 4 is a screenshot of a notification screen notifying the employee of the employee's request for partial payment for a specific shift;

FIG. 5 is a screenshot of the employee's multiple employers using the application on the employee's device as well as the employee's positions with those employers;

FIG. 6 is a screenshot of a notification screen for a manager notifying the manager of a pending report for approval or rejection;

FIG. 7 is a report screen for a manager to approve or reject where the employee's location during the shift has not been location verified;

FIG. 8 is a screenshot of a user interface screen where an employee enters information regarding a specific shift;

FIG. 9A details a screenshot for a time limited request for a partial payment by an employee;

FIG. 9B details a further screenshot for a time limited request for a partial payment by an employee;

FIG. 10 is a screenshot detailing a balance in an employee's account as well as the time left for which the employee can request partial payment for a specific shift;

FIG. 11 is a notification screen notifying the employee that a requested partial payment has been approved and that the funds have been disbursed to the employee's account;

FIG. 12 is a reporting screen for the employee that details the partial payment disbursed;

FIG. 13 is a screenshot for a manager detailing which reports are pending for approval or rejection;

FIG. 14 is a flowchart detailing a method according to one aspect of the invention;

FIG. 15 is another flowchart detailing another method according to a further aspect of the invention; and

FIG. 16 is a flowchart detailing a further method according to another aspect of the invention.

### DETAILED DESCRIPTION

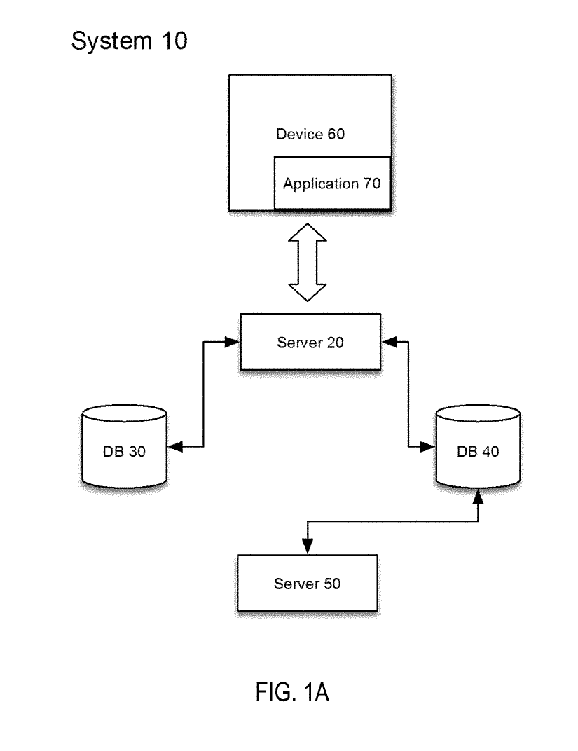

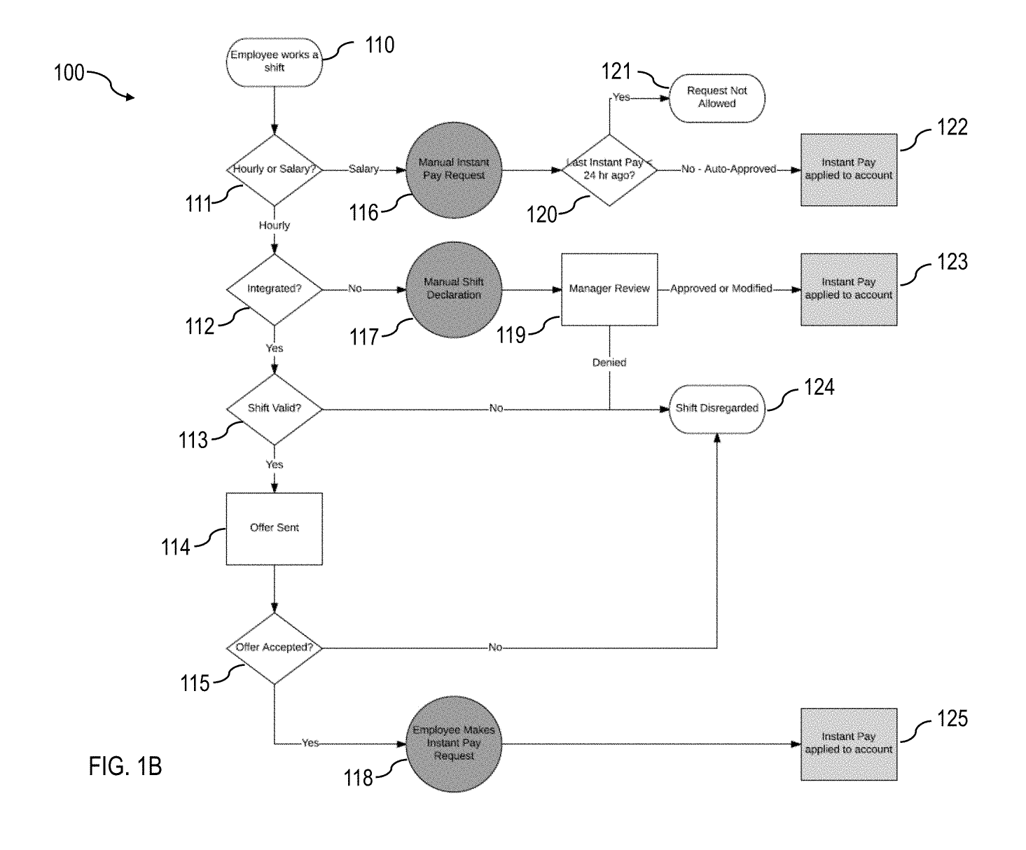

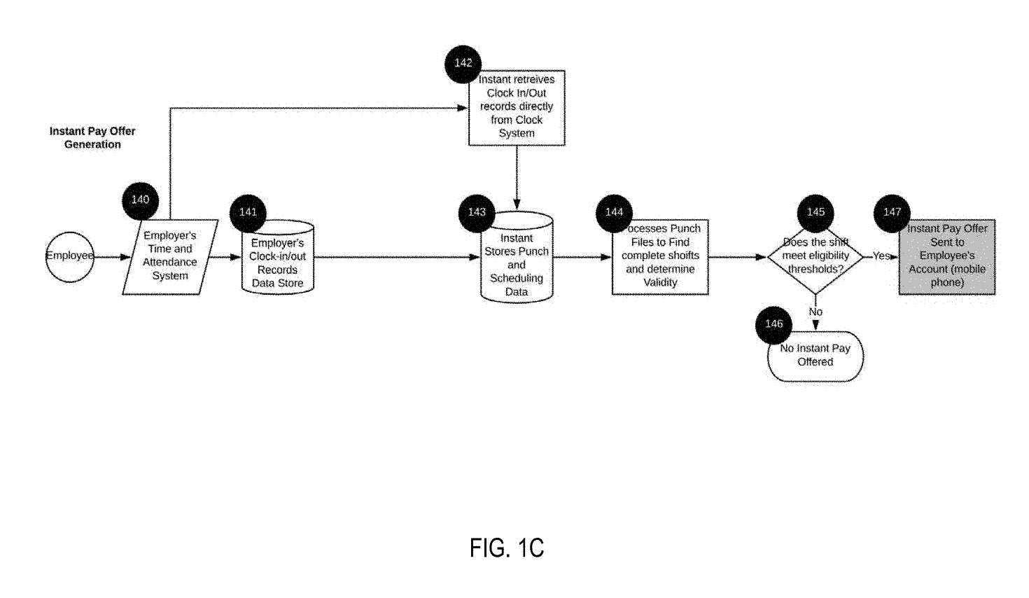

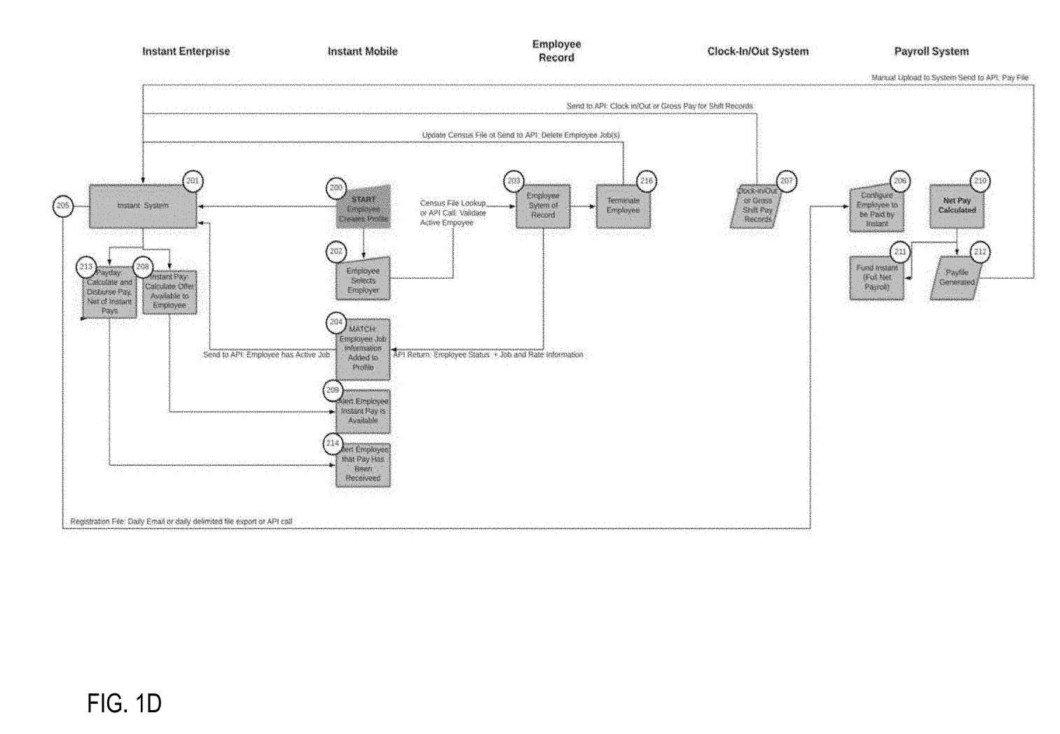

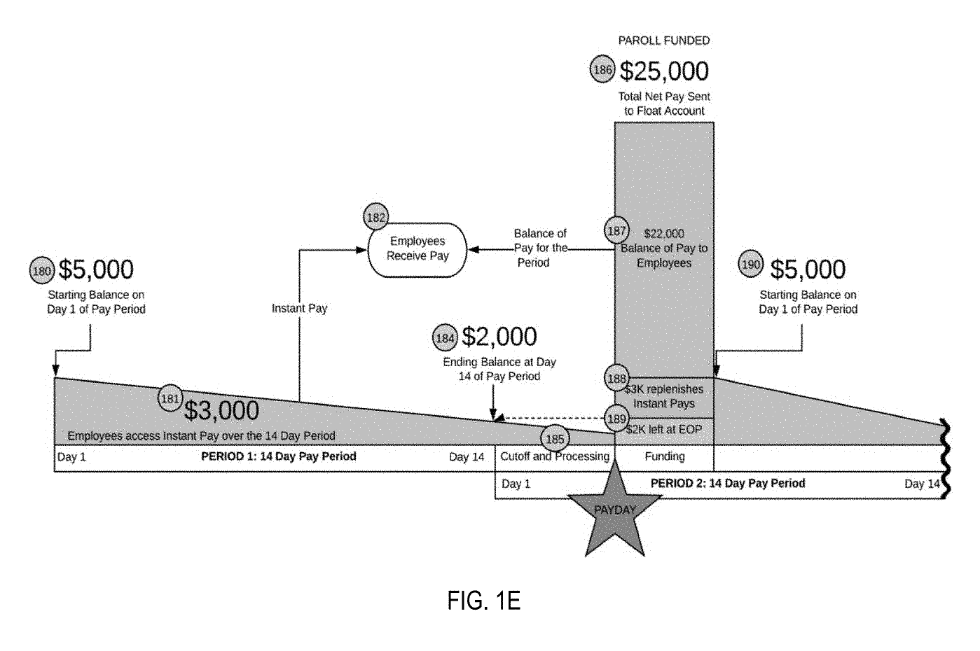

Referring to FIG. 1A, a block diagram of a system 10 according to one aspect of the present invention is illustrated. As can be seen, the system 10 includes a first server 20 in communication with a first database 30. The first server 20 is also in communication with a second database 40 which, in turn, is in communication with a second server 50. The first server is also in communication with an employee user's mobile computing device 60. Within the device 60 is an application 70 that operates to regularly update the first server 20 with the location of the device.

The system 10 operates in one embodiment by allowing a worker (employee, contractor, or the like) to record their presence at the place of work by way of the application 70, once the employee has completed a work shift on the employer's premises. The employee's location for the duration of the employee's shift is then continuously tracked by the application 70 to determine if the employee has stayed within the employer's premises during the shift. Once the employee's shift is over, the employee can declare the duration of their shift and submit it to the employer by using the application 70. Once this is done, the application 70 correlates the declared time with the time spent at the employer's place of business to the server 20. The server 20 then verifies that the employee was in the employer's premises throughout the employee's shift. Once confirmed, the server 20 then retrieves the employee's information from the first database 30. This information includes the employee's employment status with that particular employer (i.e. to confirm that the employee is indeed employed with that employer), and the employee's gross rate of pay or remuneration (e.g. an hourly pay rate). The server 20 then calculates the employee's gross remuneration for that particular shift, taking into account whatever is necessary including the employee's rate of pay and how long the shift was. Once the pay has been calculated for the shift, the server 20 then calculates a set percentage of the gross amount payable to the employee and this is then to be disbursed to the employee. Prior to disbursing this amount to the employee, the server 20 first sends the details regarding the shift (as well as possibly the calculations taken for the employee's pay and any other pertinent details) to the employee's supervisor. These details are sent to the supervisor's computing device for approval and, once approved, the server 20 can allow the pre-set percentage of the employee's pay to be made available to the employee. This pre-set percentage represents a discount rate applied to an employee's gross hourly wage. The available pay is based on a discounted hourly rate to account for minor inaccuracies and to ensure sufficient funds are available for taxes when payroll is processed. As an example, the discount rate percentage may be 50%. For this example, 50% of the employee's gross remuneration or pay for the shift is then made available to the employee. The purpose of the discount rate is to allow for discrepancies in the pay requested and the actual maximum payment that should be allowed. For example, employers may review and adjust their employees shifts just prior to processing payroll. Since the system may utilize the unadjusted raw clock-in and clock-out data in integrated implementations, it is possible that there could be an over or under payment for any given shift. This factor, as well as the necessity of accounting for and remitting payroll source deductions are the primary reasons that a discount rate is applied to the gross pay amount of each shift (i.e. the amount of pay available is the gross wage for the shift or day multiplied by the discount rate). Employers, in some cases, may temporarily alter the normal discount rate as a way of incentivising employees to work on these days.

It should be noted that, to make the amounts available to the employee, the server 20 communicates with the second database 40. The second database 40 records and tracks the amounts available to the employee through that employee's account detailed in the second database 40. The second database 40 can hold employer float accounts that may be a virtual or a physical bank account. The float account holds a set value of funds for the employee. This account can be directly linked to the pre-paid card platform which enables immediate movement of funds to an employee's account. For example, the employee can access the balance of funds in his account detailed on the second database 40 by way of a financial device (e.g. debit card, credit card, prepaid card) issued to the employee. In a preferred embodiment, the financial device is a pre-paid card tied to a pre-paid card platform. The pre-paid card platform is a system that is used to issue “Instant” branded, or other branded, pre-paid cards and associated accounts to employees. For purposes of the present detailed specification, the term “Instant” is used to describe the overall system of the present invention.

The system handles the loading of funds onto the accounts as well as processing the spending of funds from the accounts. The employee can use the pre-paid Debit card or other financial device at suitable locations (e.g. banks, retail stores, ATM/cash machines). Once at one of these locations, the employee uses the financial device and this causes a suitable server associated with that location to contact the second server 50. This second server 50 can cause the transfer or disbursement of funds to another account or institution of the employee's choice. Thus, the employee can transfer funds from his account tracked on the second database 40 to a bank account, purchase goods or services by using the financial device to pay for the goods or services, or have cash disbursed to him. Once the employee has transferred or withdrawn funds from his account, the second server 50 reduces the amount available to the employee by causing the employee's account on the second database 40 to be reduced.

The float account may be either a virtual or a physical bank account that holds a set value of funds that are placed on deposit by employers. The float can be configured as one for each business location or multiple locations can be served by one float. Each float account is linked to the pre-paid card platform which enables immediate movement of funds to employees' accounts. Funds from the float accounts are used to satisfy payment requests as they occur throughout the course of an employer's normal pay period.

The float account can be automatically replenished. On payday, employers can deposit into the float account the total net pay for each employee being paid irrespective of any payments taken during the active pay period. The system can remit the amount due to each employee net of any prior payments taken. The result is that the total of all payments now remains in the account, automatically bringing it back up to the starting amount. The cycle can repeat every pay period. The key design feature of the float account is that it places all reconciliation of payments downstream of the existing payroll process, thereby placing minimal or no operational burden on the existing payroll staff. In other words, by using the float account, the system obviates the need to report the dollar amounts of payments taken by each employee to the payroll team for the purposes of having those funds withdrawn from the paycheck. Instead, the system takes care of all the calculations and financial reconciliation.

These float accounts may also be used to fund other payments when employers wish those funds to be immediately available to their employees. This feature is particularly useful when it comes to paying tips, commissions, spiffs, or similar payments. In the case of tips specifically, historically tips are paid to employees daily in cash. Since cash increasingly only accounts for less than 90% restaurant payments, restaurants are having to resort to either bringing cash into their restaurants to satisfy this need, or they resort to paying tips to employees on paychecks. However, paying tips on paychecks is an unpopular option with employees. The system allows employers to pay tips electronically on a daily basis. In these cases the float account is replenished by way of a corresponding ACH or Wire Transfer equal to the total of such payments delivered in a set period or on a payment by payment basis.

Referring to FIG. 1C, the process of the invention is described in further detail below, in one embodiment:

Step 140—Employees record their hours worked (thereby generating ‘clock in and out data’) into a time and attendance system. The system may include also include information on the employee's work schedule.

Step 141—The clock in and out data is extracted and stored in a database managed by the employer.

Step 142—The clock in and out data can also be extracted directly by Instant.

Step 143—Instant stores the clock in and out data and scheduling data if available

Step 144—Clock in and out data is processed to determine eligibility for the generation of an Instant Pay offers. Clock-in records are matched with clock-out records to create a shift, and the resulting shifts are either scored by a machine learning or AI system or similar or passed through an algorithm.

Step 145—The system determines if the Shift meets eligibility criteria for the generation of an Instant Pay offer.

Step 146—If the Shift does not meet eligibility criteria, no Instant Pay offer is generated.

Step 147—If the Shift does meet eligibility criteria, an Instant Pay offer is generated.

The flow of funds of the present invention, in one embodiment, is described below with respect to FIG. 1E:

Step 180—At the beginning of the period a financial account (float account) is funded with sufficient funds to fulfill all anticipated pay requests during the period and for the additional time between payroll cut-off and the time it takes to process and fund payroll.

Step 182—During the course of the period the float account's balance is reduced as employees access their pay by way of Instant Pays.

Step 184—At the end of the period, a balance will remain in the Float and is recorded as the period ending balance.

Step 185—While payroll is being processed the float account continues to be utilized to fulfill pay requests. These payment are, however, allocated to the new period.

Step 186—The employer funds the full pay amounts for employees that are being paid using this payment system into the float account.

Step 187—For each employee, the system subtracts the amount of pays taken (if any) from the full net pay amounts sent and remits the balance due to the employee. At this point employees are now paid in full.

Step 188—The reminder automatically equals the amount of pays funded in the period and remains in the float, automatically replenishing it.

Step 189—The period ending balance of the float (184) plus the replenishment (188). balance to the period starting balance (180).

Step 190—As a result, the float is fully funded and ready for the next cycle.

This process allows employers to avoid having to deduct any real-time pay amounts as part of the process, as such reconciliations are now handled after the completion of the normal payroll process.

It should be noted that the application 70 may take the form of an “app” or application suitable for execution by computing devices such as mobile phones, smart phones, computer tablets, or any other computing device.

FIG. 1B illustrates a flow chart 100 of a system according to an embodiment of the invention. This flow chart 100 shows the interaction of the employee, through his or her device and software application, with the payment system, though the back-end server software. The process enabled by the software applications provides hourly or salaried employees with on demand access to a percentage of their earned income. For hourly employees, income may be deemed earned when a shift has been completed. For salaried employees, income may be deemed earned by dividing the annual salary by 365 days and making that portion available daily, less the discount rate.

The entire system, in an embodiment, comprises an employee application, a back office software component, and various 3rd party software systems including a per-paid card platform as well as banking systems including float accounts. The back office component comprises a web application. This web application allows managers with access to administrative features to manage employees, retrieve reports, and initiate the movement of funds to employees.

In step 110, the employee works a shift. In step 111, the system checks whether the payment of the employee is hourly or salary based. If the shift was salary based, the system, in step 116, can make a manual payment request. The payment request can be made through the employee application used by the employee. This employee application also allows employees to manage their funds and their account. The employee application can also be used by the manager to verify new employees during the onboarding process and to manually approve pay requests, such as those in step 119.

Once the payment request is made, the system, in step 120, checks if the last payment was less than 24 hours prior to this request. If the last payment was less than 24 hours prior, the system will reject the request in step 121. Otherwise, the system will automatically approve the request and a payment is applied to the employee account in step 122. The employee account can provide various levels of access to certain features. In the case of employees receiving payment through the system, the account can be associated with, or linked to, a pre-paid Visa or MasterCard or similar account including a block-chain account where the employee's funds are held in combination with a bank account which exists in the background.

The system may get the employee's actual pay rate from a variety of sources. These sources include the employee entering their rate into the system and then the rate being validated by the employer, by way of a census file (a file provided by the employer that contains employee data including rates of pay), or any computer system that can be queried and that will return the rate of pay for an employee. Such systems include payroll systems, human capital management systems and other employee systems of record. Note that it is not uncommon for an hourly employee to have several positions or jobs at an employer and for each of these jobs to have a different hourly rate of pay. It is therefore necessary for the system to be able to identify the specific job being worked during the shift. Such “job code” data may be included in the shift data. Otherwise, a flat rate per hour worked method can be used.

For hourly employees, income can be made available immediately after the shift or at any time after their shift before the regular payday. The availability may be constrained due to the timekeeping system. The payment amount available, in an embodiment, does not carry over from shift to shift or day to day.

If the payment of the employee is hourly based, the system checks in step 112 whether the payment system is integrated with the shift system. If the payment system is not integrated, a manual shift declaration can be made in step 117 by the employee. This manual declaration is subject to a manager review in step 119. Note that payment system implementing process 100 is not the system of record for hours worked by employees.

The manager may be an employee at a business that may be receiving pay through the system but that also has permissions to manage the payment system, approve payments, and initiate the transfer of money from the business to the employee. If the manager approves the request, a payment is applied to the employee account in step 123. If the manager does not approve the request, the shift is disregarded by the payment system in step 124.

If the payment system is integrated into the shift system, such as though a timekeeping system that tracks or records the hours worked by the employee, the system will check if the shift is valid in step 113. The system may check by comparing the clock-in and/or clock-out times of the employee in the timekeeping system versus the employer's scheduling data, or by checking to see if the clock out portion of the shift was machine generated, indicating the employee may have not properly clocked out, or by comparing the shift to the GPD data to correlate hours worked with hours spent at the place of employment. The system may receive the raw clock-in and clock-out data through a variety of means including but not limited to real-time integration with the timekeeping system, such as through an API or through a periodic file upload in CSV, XML, or other format. When received, the data is processed by the system. Clock-in records are automatically matched with corresponding clock-out records on an employee by employee basis. This process can be done in real-time as the records are received. When a shift is identified the system determines the number of hours worked, as well as the eligibility and validity of the shift based on a variety of rules. For example, if the shift is too short, e.g. less than an hour, it is deemed ineligible for payment. Alternatively, shifts that are longer than 8 hours may be truncated to a maximum eligibility of 8 hours. Additionally, records that indicate that they were machine generated, e.g. that the system automatically clocked an employee out as part of a close day routine, are also deemed ineligible as they likely indicate that the employee forgot to clock out. Thus, the true length of the shift may not be known, unless a corresponding automatic record is found immediately after the previous automatic record. In this case, the records may be combined into a larger shift, as these records may indicate that the employee's shift was split over multiple business days.

If the shift is not valid, the shift will be disregarded by the payment system in step 124. Otherwise if the shift is valid, an offer will be sent to the employee, via their device or other interface, in step 114. The employee may reject the offer in step 115, and the shift will be disregarded by the system in step 124. Otherwise, the employee may accept the offer in step 115 by making an pay request in step 118. A payment will then be applied to the employee account in step 125.

In some embodiments, the application 70 can be configured to take advantage of the capabilities of the computing device 60 such as, for example, GPS (global positioning system) capabilities, wireless networking capabilities (e.g. Wi-Fi connectivity), and cellular data transmit and receive capabilities (e.g. LTE connectivity) to track the device 60's location and to communicate with the first server 20. Depending on the configuration of the device 60 and the settings on the application 70, the application 70 can, when active, continuously track the device 60's location once on the employer's premises using the device 60's GPS capabilities. The application 70 can then provide continuous updates (e.g. an update at specific time intervals can be sent to the server 20) to the server 20 as to the device's location. Conversely, instead of providing continuous updates to the server 20, the application can check on the device's location at specific intervals and record whether the device is within the employer's premises or whether the device (and therefore the employee) has left the premises. Then, once the employee's shift is over, the application 70 can upload the log of the device's whereabouts during the shift to the server 20. As another option, instead of having the application 70 track the device's location, the server 20 can periodically query the application 70 for the location of the device 60. As an example, the server 20 can, every 15 minutes, 30 minutes, or hour, send a query to the application 70 as to the location of the device 60 as determined by the GPS subsystem of the device. In response to this query, the application reads the GPS coordinates for the device's location and sends these coordinates to the server 20. In another embodiment, the server 20 may, at specific time intervals, send a query to the device along with at some GPS coordinates (or a range of coordinates). The device then receives these coordinates and determines if the device's GPS coordinates correspond (with an acceptable margin of error) to those coordinates. The margin of error may be set so that a match between the received coordinates and the device's GPS coordinates need not be an exact match. A match would indicate that the device is still at the employer's location. If there is a match, the application then sends a positive indication that such a match has occurred.

The server 20 can thus determine, based on the continuous updates of the device's location or based on the device's location log as detailed above, whether the device (and hence the employee) has been at the employer's location for the duration of the employee's shift. In one embodiment, the server is notified by the application that the employee has started the shift by the employee “clocking in” to the application. At the beginning of the employee's shift, the employee can “clock in”, register his or her arrival for the shift, or otherwise indicate that he or she has started the shift. This can be done by the employee launching the application and then indicating that the shift has started. The employee can, depending on the configuration of the application, also indicate which job/position he/she is performing for the shift. As an example, the employee, once he has clocked in, can, from a drop down menu, select his job or position for that shift. For some employers (e.g. restaurants/bars) the employee can have different job descriptions depending on what might be needed for that specific shift. As an example, an employee might be asked to tend to the bar for that shift, or be a server, a busboy, a greeter/usher, or a short-order cook. Depending on the arrangement between the employer and the employee, each position may have a different rate of pay. Thus, depending on which position is executed by the employee for that shift, that employee's pay rate may change. Once the employee has clocked in and has selected the job for that shift (if necessary), the server is informed of the clock in as well as the employee's position for that shift. This may be done by sending a data packet from the device to the server with data indicating the identity of the device and other relevant data (i.e. the employee's identity, the employer's identity, the time the employee started his shift, as well as the job/position the employee is performing for the shift (if applicable)). The server then logs the time stamp of when the clock in occurred as well as the job or position indicated by the employee for that shift. Once the shift has ended, the employee then clocks out or registers that the shift is over. Again this can be done by sending a data packet from the device to the server with the relevant data such as the employee's identity, the employer's identity, and the time the employee clocked out. The server can then calculate the employee's pay for the shift based on the employee's time clocking in, the employee's time clocking out, and the job/position indicated by the employee. The server may need to retrieve data from the first database detailing the rate of pay or remuneration (e.g. an hourly rate) for the job/position indicated by the employee. If a job/position was not indicated, then the first database should have data detailing a rate of pay for that specific employee and that specific employer.

To assist in the completion of the data required from each employee at the start of the shift, the fields in the app can be automatically filled in from data supplied by the employer. If the employer already has a set schedule of shifts, positions, and employees for each shift and position, this schedule can be periodically uploaded, or in real-time as employee shifts are completed, by the employer to the server. The server can then parse this document to retrieve the relevant data and, once the employee has clocked in for a specific shift, the app can prompt the employee with a pre-filled data set. The employee merely has to confirm that the entered data is correct. If there were changes to the schedule that were not indicated in the schedule uploaded to the server, the employee can edit/amend the pre-filled data set. As an example, if an employee is set to work as a server for a specific shift but is, instead, asked to work as a bartender due to a large influx of people at the bar, then the employee can change the position for that specific shift from server to bartender. This change can then be confirmed by the shift's manager once the shift is over (see below for more explanation). It should also be clear that, in some implementations, the employee may detail who his or her manager is for that specific shift. The eligible managers can be selected by the employee from a drop-down menu to ensure that the proper manager is sent the reports for that shift for that employee. The manager can then confirm the shift data as will be explained below.

While the above description notes that the employee clocks-in and/or clocks-out using the app, in other embodiments, the employee may not be required to perform such tasks. In some embodiments of the invention, the app passively notes that the location of the device corresponds to the location of an employer premises and that the time indicates the beginning of a scheduled shift. The app can then start logging/reporting the device's location until the end of the shift or the app can give the employee user the option for an app-based clock-in. The clock-in may not be necessary as the app merely starts tracking/logging the device's location for the duration of the scheduled shift. The employee user may opt for an app-based clock in if details about the scheduled shift have changed such as the position the user is to work for the shift or the length of the shift has changed.

It should be clear that, for some employers, employees are entitled to unpaid breaks. Every time the employee takes a break, the employee may indicate on the application that a break has been taken as well as the length of time for that break. Alternatively, in embodiments where the employee is required to perform an app-based clock-out, when the employee clocks out, the application can prompt the employee for the number of breaks taken as well as the length of time for each break. These data point are then sent to the server along with the data regarding the employee's clocking out.

For the clocking out step, the employee may manually clock out by calling up the app and then end his or her shift. Alternatively, the app can automatically be called up if a predetermined schedule for the shift has been uploaded by the employer. If the schedule has been provided beforehand, the device can, when the scheduled end of the shift occurs, execute the app and prompt the employee for additional data regarding the shift, or the server could send an offer to the device using the data set regarding that specific shift. Alternatively the employee could be asked to confirm or dismiss the clock out. Once the employee has confirmed a clock out (whether automatically prompted or by manually calling up the app), the app can then notify the server of the time stamp when the employer clocked out. The app can then prompt the employee to confirm the data set regarding that specific shift including the time the employee clocked in, the time the employee clocked out, the position(s) worked by the employee (as entered by the employee when the employee clocked in), the number and duration of breaks taken by the employee, any overtime performed by the employee, as well as the manager for the shift. These data points may be presented to the employee from the data set entered by the employee when the employee clocked in for the shift. The employee can then confirm these data points and the data set is then finalized and uploaded to the server. The server can then calculate the employee's pay for that shift and report the data set for the shift for that employee to the relevant manager.

In another embodiment, the employee is not required to perform an app-based clock-out. When the employee's scheduled shift is over, the device merely stops logging/tracking the device's location and uploads the tracking log or, where necessary, sends the final location track to the server.

For industries where customer tips or gratuities form part of the compensation to the employee, each employee, when clocking out or when the shift ends, enters the amount of tips received or is prompted to enter the amount of tips received. These tips are turned into the management/employer at the end of the shift. The amount received by the specific employee in terms of tips is entered by the employee in the app prior to clocking out or when prompted by the app. The total amount of tips received by all the relevant employees for that specific shift is then tallied up or totalled by the server and is then apportioned accordingly to the relevant staff. Depending on the configuration of the app and the system as well as the arrangement with the employer, the server may total up the tips received for a specific shift and then apportions the tips to the various employees when calculating each employee's total or gross pay. Or, alternatively, the amount of the pay to be disbursed to each employee does not take into account the tips received. The amount of pay coming from the tips can be disbursed to the employee at the set pay period with the tips received by the employee and entered by the employee acting as the record for the employer for calculating how much to pay each employee.

It should also be noted that, when the employee is clocking in, the app or the interface which prompts the employee about clocking also confirms or prompts the employee whether he or she is at the employer's location for a shift. A simple button on the app that confirms whether the employee is at the location for a work shift should be sufficient. This step may be necessary as the employee may be at the employer premises not for work but for any other number of reasons. As an example, if the employee's shift starts at 6 pm at the employer's premises (e.g. a restaurant), the employee may be at the premises by 4 pm to, for example, have a meal there before the shift is scheduled to start. Once the employee has confirmed that he or she is at the premises for a work shift, then the app may continue to request further information regarding the employee's shift. One option for the system would be for the app to continuously monitor the device's location and, once the location corresponds to an employer's premises or location, a “clock-in” prompt is provided to the employee. If the employee is not there for a shift, then the employee can dismiss the prompt. If the employee is there for a shift, then the employee can clock-in and provide the necessary information for the specific shift.

To determine the employee's pay or remuneration for a specific shift, the server uses the data received from the device as well as data from the first database. The server receives the employee's clock-in time, the employee's clock-out time, and, if applicable, the employee's job/position. As well, the server receives the length of the employee's breaks (for employers that do have an unpaid break policy). The server then queries the first database to determine the rate of pay for the employee's indicated job/position. If the job/position is not variable, then the server simply retrieves the employee's rate of pay from the first database for that employer. (As noted, the employee may have different employers and each employer may have a different rate of pay for that employee) The server then calculates the amount of time elapsed between the employee's clock-in time and clock-out time. The employee's break times (i.e. the amount of time used by the employee on his breaks) can be deducted from the amount of time elapsed between clock-in and clock-out. The result is the amount of time that the employee is to be compensated for and this amount of time is multiplied by the rate of pay retrieved from the first database. The server then uses this calculated gross amount to determine a partial payment for the employee. The result is the employee's gross pay for that particular shift.

As noted above, in one alternative, the device creates a log into which the results of the device's location during the shift are recorded. Thus, instead of having the device periodically report to the server about its location or instead of the server periodically querying the device as to the device's location, the device periodically enters into the log the device's location. This log can then be uploaded to the server at the end of the shift along with the employee's identity, the employer's identity, and data regarding the shift (e.g. start time, end time, position for the employee, how many breaks were taken by the employee etc., etc.). Note that while this information is stored in the log, this information may still be uploaded to the server separately from the log. The server, once it receives the log, can then determine the employee's pay for that particular shift using the information contained within the log as detailed above. As well, the server can determine if the employee ever left the employer's premises during the shift. This can be done by determining the limits of the employer's premises in terms of GPS coordinates. This can be done by, for example, determining a center of the premises (in GPS coordinates) and then determining a radius from that center that defines the extent of the employer's premises. As an example, if the employer's premises is a small takeout location, the radius may only be 20 meters from the geographical center of the employer's location. Conversely, if the employer is a large corporation with a large factory, the radius may be hundreds of meters from the center of the location. If the device's GPS coordinates during the shift is ever outside the predetermined radius from the center of the employer's location, then it can be concluded that the employee probably left the premises. Depending on the configuration of the system and the employer's policies, the employee may be docked pay for the time the employee is outside of the employer's premises. This time away from the employer's premises may be taken into account when calculating the employee's final pay for that particular shift.

Once the server has determined the employee's gross pay for the shift (without taking into account any deductions), the server can then send the details about the employee's recently completed shift to the employee's supervisor/manager for approval. The server, after performing the necessary calculations, prepares a report for approval by the manager/supervisor. The report may include a number of data points for approval by the manager including: the employee's name, the location of the shift, the hours for the shift, the job/position(s) for the shift, the pay grade/pay amount per hour for each position, how many breaks and how long were the breaks for the shift, instances (if any and for how long) the employee was out of the employer's premises during the shift, and the total amount of the employee's gross pay for that shift. If the employee's location has been confirmed throughout the shift as not having left the employer's premises, the report can be stamped as “location verified” in that the employee's device has been verified as not having left the premises during the shift. Conversely, if the employee was confirmed as not being within the GPS boundaries of the employer's premises during the shift, the report can be labelled as being “unverified”. Depending on the configuration of the system, the data points on the report may not include all of the above possibilities.

Once the report is prepared, it is then sent to the manager's device. The manager's device may be a tablet, a computer, or a mobile telephone device. Depending on the configuration of the system and the preferences entered for the specific manager, the report may be sent to the manager's mobile device or, if the mobile device is not available, the report may be sent to a workstation (e.g. a computer) accessible to the manager. The report may be in the form of an email, a text message, or a notification on a counterpart app on the manager's mobile device. The manager can then review the details of the report and either approve or reject the report. For ease of the review and approval, the report may be provided with large APPROVE and REJECT buttons. The manager only has to be press the relevant button on the report to either approve or reject the report. Pressing the relevant button either on the app or in the email sends an approval or a rejection of the report to the server. If approved or rejected on the app, the button sends a signal to the server as to whether the report and its contents have been approved or rejected. If in the email, the approval or rejection causes a reply email to be sent to the server with the relevant identification of the report and whether that report has been approved or rejected by the manager. It must be noted that a rejection by the manager may mean that one or more data points in the report may need confirmation and that the manager needs to confirm those data points before confirming the report.

It should be clear that the label “location verified” for reports sent to the manager provides the manager with a level of confidence that the employee was in the premises during the shift. If a report is labelled as “unverified”, the manager can then rely on his or her own judgment about whether the employee was at work during the shift or was not fully working during the shift. It should be clear that the “unverified” label can be attached to any report where, at some point during the shift, the employee's location indicated that the employee was not in the employee's premises.

It should also be clear that, in some embodiments, the manager/supervisor may edit/amend the report. As an example, the employee may, according to the report, have left the employer's premises for two hours during the shift. If this absence was allowed by the manager (e.g. to attend to a work related matter), the manager may amend the report so that the employee is not docked for his or her absence from the employer's premises. Or, as another example, an employee may have had a split shift where the employee is performing one duty for part of the shift and is performing another duty for another part of the shift with the two duties having different rates of pay. For this example, the manager may adjust the hourly rate of pay for the employee to reflect the split nature of the job performed by the employee during the shift. The manager/supervisor may adjust any of the data points on the report to adjust the reality of what occurred during the shift. Once the manager has adjusted or amended the report, the manager can approve the report. This amended report will then be the basis for the server to disburse funds to the employee. As an example, if the original report detailed that the employee is entitled to a gross pay of $100 for the shift, the manager may adjust the rate of pay so that the employee is entitled to be paid $120. This new amount and the new rate of pay will thus be used by the server to determine how much to disburse to the employee. The manager may append notes to any report which he or she has either changed, amended, approved, or rejected.

In the event the system is not configured to allow the manager to adjust the report, the manager may reject the report and enter notes in the report detailing what may need to be changed. Depending on the amount of automation of the system, these notes may be used by the server to generate a new report for approval or these notes may be used by a human operator to prepare a new report for approval by the manager.

To ensure proper recordkeeping, the approved report for the employee for that shift is received and stored by the server in the first database and forms part of the employee's record. Rejected reports along with their notes from the manager may also be stored with the employee's record in the first database to ensure that a proper record of what occurred is kept.

Once approved, the approval is sent to the server and causes the server to disburse funds to the employee. It should be noted that if the manager/supervisor has not approved or rejected the report within a given time frame, the server sends a reminder that the report has to be reviewed. The reminder can take the form of a text message, an automated phone call, an email, or any other immediate reminder to the manager that can be delivered on the manager's mobile device or tablet.

It should also be noted that not all the funds for the particular shift is disbursed to the employee. Depending on the configuration of the system, only a percentage of the employee's take home pay is to be disbursed to the employee. As an example, 25%, 50%, or 75% of the employee's gross pay for a shift may be disbursed to the employee. If, as another example, an employee earns a gross pay of $100 for a specific shift, depending on the configuration of the system and the arrangement with the employer, $25, $50, or $75 may be disbursed to the employee by the server.

To disburse funds to the employee, the server 20 (which is in communication with the employee device, the manager device, and the first database and which calculates the employee's gross pay for each shift based on the data received and data in the first database) communicates with the second database 40 to credit (i.e. add to) the employee's account the amount to be disbursed to the employee for that specific shift. By adding to the employee's account detailed on the second database 40, the first server 20 thereby makes available to the employee a percentage of the gross total pay for that shift that the employee is entitled to. A second server 50 operates as a conduit for the employee to access the funds represented by the balance in the employee's account in the second database. As noted above, the employee is provided with a financial device that allows the employee to access the funds. The financial device may be a debit card, a credit card, a bank card, or any other financial device that provides the employee with access to his or her account detailed on the second database.

Once the employee's account has a balance (i.e. the account has money) the employee may access the funds by using the financial device. The employee may use the financial device for purchases or fund transfers or to withdraw cash at stores, outlets, banks, ATMs (automated teller machines), and other locations which allow the use of such devices. In one example, the employee uses the financial device at a terminal to withdraw cash. Once the employee has entered his or her personal identification number and has withdrawn cash, the terminal notifies the second server that funds have been withdrawn. The second server then updates the second database as to the amount of funds withdrawn and the employee's account is debited (i.e. reduced by) the amount. In the event the employee wishes to transfer funds to another institution (e.g. a bank or other financial institution), the institution's servers contact the second server and the second server causes the funds to be transferred to that institution. Again, the employee's account is reduced by the amount transferred to the other institution. The second server and the second database operate similarly to a server and database combination of a financial institution as the second server operates as a processor for requests for funds while the second database operates to maintain, update, and ensure the integrity of the records for the various accounts.

In one implementation of the combined system, the first and second servers, as well as the first and second databases, are operated by the same corporate entity or by related corporate entities. This ensures that an employer, wanting to provide early access to funds for its employees, merely has to coordinate and/or deal with one corporate entity when dealing with providing early access to funds for its employees. Or, in another implementation, the first server and the first database are operated by one entity while the second server and the second database are operated by a completely different and unrelated corporate entity. The operator of the first server and of the first database only thus has to operate as a conduit for early access to funds for its employees for an employer while the operator for the second server and for the second database only needs to operate as a financial institution.

It should also be clear that the system detailed above also works for an employee who may be employed by multiple employers. As an example, an employee may be employed as a server in one restaurant, as a bartender/serving staff for a second restaurant, and as a factory line worker for a third employer. All of the employers for this example may be using the system as noted above. For this example, the employee merely needs to verify/identify the correct employer when clocking in. Depending on the configuration of the system, the employee may not even be given an option for the employer as the system may predetermine for which employer the employee is about to start a shift with as the employer's location would, ideally, identify the employer. Thus, instead of providing the employee with a listing of current employers, the system on the employee's device may merely request that the employee is about to start a shift for employer X as opposed to starting a shift for employers Y or Z.

In another implementation of the present invention, instead of automatically paying the employee a specific percentage of the pay the employee is entitled to, the system may use this as an option. The employee may, when clocking out, request for a partial payment for the shift just ended. Conversely, the employee may opt for payment during the employer's regular payroll run (e.g. a once or twice monthly payment to the employee). Once the employee has clocked out, the employee may request for a partial payment with the rest of the pay to be paid to the employee during the employer's regularly scheduled payroll payments. As well, in another embodiment, the employee may be given a set time after a shift in which to request for the partial payment. As an example, the employee may have up to an hour or two after the end of a specific shift to request for a partial payment for that shift. Once the employee has requested such a partial payment, then the system may forward the report for that particular shift to be sent to the shift's manager to confirm (i.e. allow) or deny the employee's request. If the employee does not opt for a partial payment, the employee's remuneration is scheduled for payment during the employer's regular pay cycle.

For clarity, an example is provided. In this example, the employee works six shifts every two weeks of five hours per shift at a pay or remuneration rate of $10 per hours. Thus for the two weeks (e.g. one pay period in a bi-weekly pay cycle), the employee would have a gross pay of 6 shifts×5 hours×$10/hour=$300. After every shift, the employee would have a gross pay of $50 per shift. If the system is configured to disburse a maximum of 50% as partial payment, then the employee can be paid a total of $25 per shift using the system of the invention. Assuming the employee takes advantage of the maximum partial payment after every shift, then, by the time the regular pay cycle has concluded, the employee would have been paid a total of $150 or 50% of gross pay. The remaining $150 (less any deductions that would need to be paid or deducted) would thus be paid out by the employer at the end of the regular pay cycle. Such deductions may need to be calculated based on the employee's full $300 gross pay. As an example, if deductions calculated for the full $300 gross pay total $40, then, at the end of the regular pay cycle, the employee would be paid $110 (i.e. the $150 left owing to the employee less $40 in deductions). Partial payments to the employee are calculated using the employee's gross pay for the shift and any deductions and/or taxes are calculated and deducted from the rest of the employee's pay due at the end of the regular pay cycle.

For the employee's convenience, the app on his or her phone may be provided with a screen that details the state of the employee's account. As an example, such a screen may detail the employee's current account balance, the last few deposits to the account, the amounts for the last deposits into the account, who the payees were for the last few deposits into the account, as well as an indication of the employee's spending/withdrawal/deposit patterns. For the employee's ease of use, a graph detailing the trend of the employee's account balance and/or the withdrawals/deposits for the account may also be provided.

Also for the employee's convenience, the app on the employee's device may also be notified once the employer has transferred funds into the employee's account as partial payment for the last shift. This may be done by having the first server send a notification to the employee's device once the employee's account has been credited with the partial payment after the manager has approved the report and partial payment for the employee's last shift.

To ensure that the reports sent to the manager for approval are dealt with in a timely fashion, the employee is notified once the report has been sent to the manager for approval by the first server. The first server, after the report is sent to the manager for approval, sends a notice to the employee. Then, if the report has not been approved by the manager within a given time frame (e.g. an hour or two), the first server sends a reminder to the manager and also notifies the employee of the delay. If, after the reminder, the manager still has not approved of the shift report, the employee may be given the option (by the first server through the app on the employee's device) to redirect the report to another manager for approval. If the employee takes this option and the report is redirected to another manager, the report is removed from the task list for the original manager and is added to the other manager's task list. The employee is also notified of this redirect action, once completed.

Referring to FIG. 1D, a block diagram is shown that outlines the flow of data between the invention and an employer's existing payroll and time and attendance systems, as described in further detail below.

Step 200—Employee uses Application [70] to create a user account and link a financial instrument such as a pre-paid Debit card to the account.

Step 201—The employee account and a corresponding financial account are created in Instant's databases.

Step 202—The employee selects an employer where they are: a) currently employed and; b) for which they'd like to receive their pay via their Instant account.

Step 203—The system looks up the employee information in the selected employer's database or by way of a direct query of the database or by querying a Census file that is sent to Instant on a periodic basis.

Step 204—If a match is found, an Active Job at the Employer is added to the employee's Instant profile

Step 205—A notification is sent to the Employer's payroll system that the employee has selected Instant as their pay disbursement choice for the particular job.

Step 206—The payroll team at the employer configures the employee's payroll record to disburse their pay via Instant.

Step 207—Clock-in and out records for Employer locations that have employees enrolled in Instant are received by the Instant system.

Step 208—The system matches clock-in and out records to Instant users that have active jobs in those locations. When a match is found, the system looks up data in a census file or queries the employer's database to determine eligibility and to calculate the amount of the offer.

Step 209—Instant Pay offers are sent to employees.

Step 210—The payroll team processes payroll and determines the net pay due to employees, irrespective of any Instant Pays taken in the period.

Step 211—The Employer transfers the full net pay amounts due to their employees to their Instant funding (Float) account.

Step 212—The employer sends funding instruction data for the pay period that contains the net pay due to each employee.

Step 213—Employees are notified that they have received their pay, net of any Instant Pays taken in the period, on their Instant account.

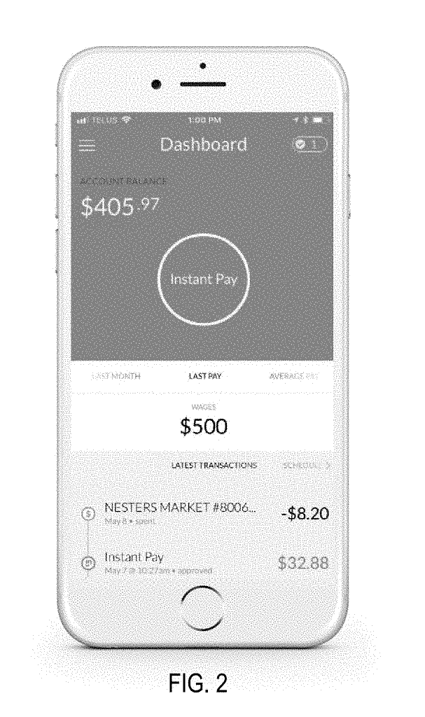

Referring to FIG. 2, a screenshot of an employee's mobile device detailing a main screen for an application according to the present invention is illustrated. As can be seen, the screen details the account balance for the employee's account as well as the most recent transactions on the account. The transactions include both credit/deposits (payments from an employer) and debit/purchases (purchase at a store). Also included on the screen is a visualization that shows the employee's spending/earning trends.

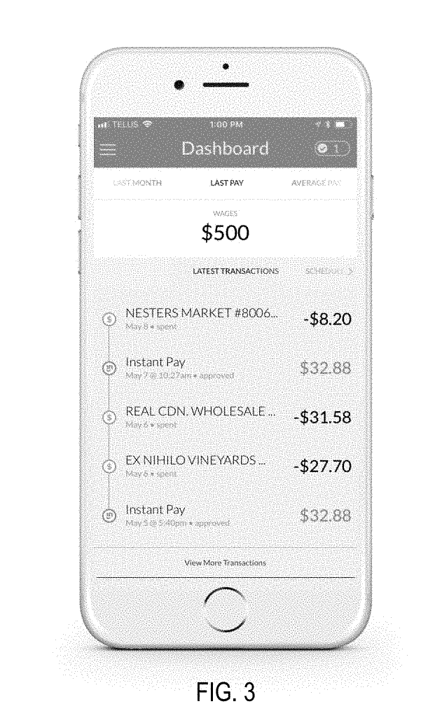

Referring to FIG. 3, another detailed screen shot of the application according to the present invention is illustrated. In this screenshot, the employee's pay and/or payments to the employee by an employer are detailed. A regular paycheck transaction is detailed along with partial payments for shifts worked are listed. The periods for the two paychecks received are detailed along with the dates for the two partial payments.

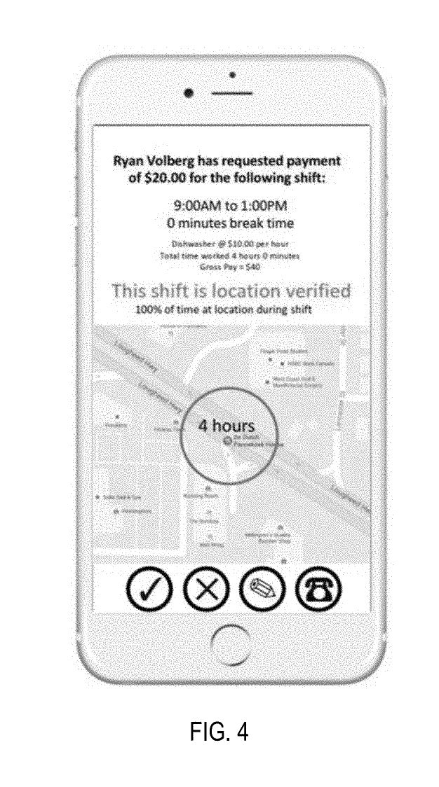

Referring to FIG. 4, a notification screen for the employee's app on the employee's mobile device is illustrated. As can be seen, the screen details a notification to the employee that the employee has requested a partial payment for a specific shift which has already passed. The screen identifies the employee, the requested payment, the time period for the specific shift, how many breaks (and for how long) were taken, the position worked by the employee, the rate of pay for that position, the total time worked for that shift, as well as the total gross pay for that shift. Included is an indication whether, according to the device's location reporting, the employee left the employer's premises. Along with this are indications of whether the employee was on-site at the start and end of the shift, how much of the shift the employee was on-site, and a map detailing the location of the employer's premises. As noted above, partial payment to the employee may be configured as optional for the employee.

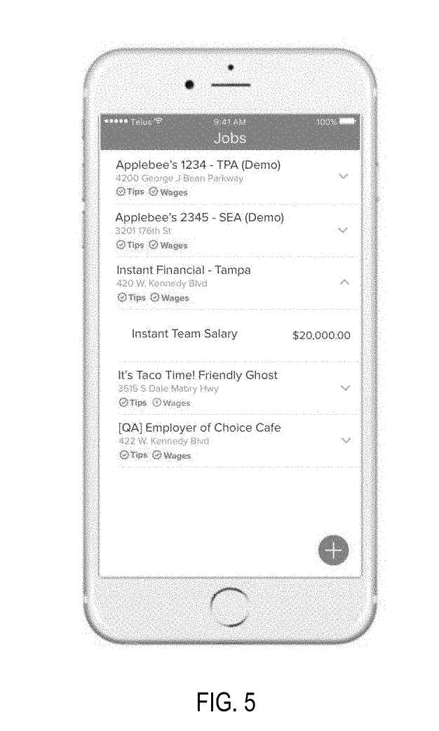

Referring to FIG. 5, the application can also provide the employee with a screen detailing how many employers the employee currently has and which positions the employee has with those employers as well as the rate of pay for each position.

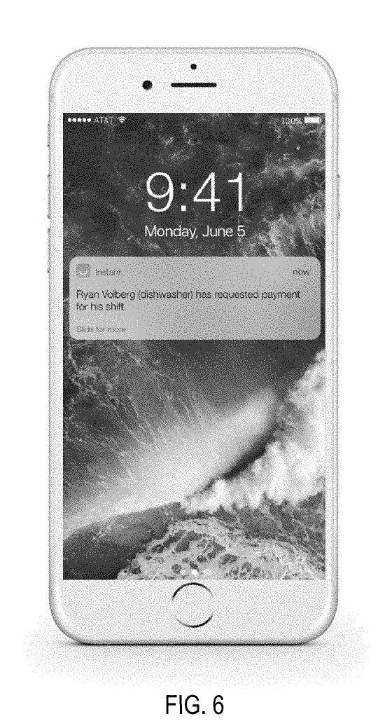

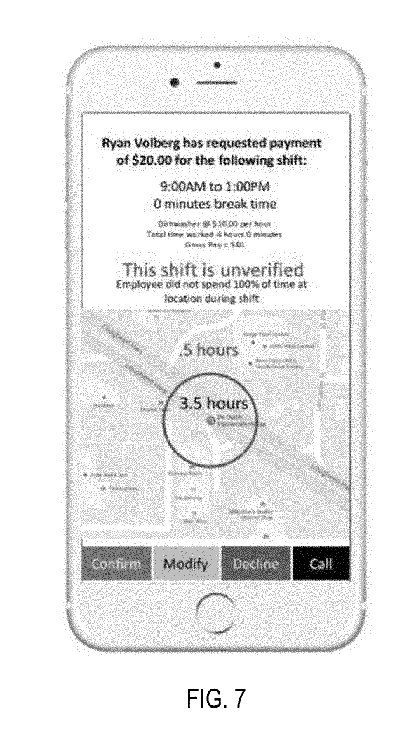

Referring to FIG. 6, a notification screen for a manager is illustrated. As can be seen, the manager is informed of a pending request for partial payment from an employee. To approve or reject the request and the report, the manager views a report similar to that in appearance to what is illustrated in FIG. 4. This ensures that what the manager sees is what the employee sees as being submitted to management. To approve or reject the report, it can be seen from FIG. 4 that a check mark or an X mark can be pressed by the manager to approve or reject the report. In this report screen (see FIG. 4) the employee is requesting a partial payment for a specific shift in which the employee was verified as being on-site for the whole shift. In contrast to FIG. 4, FIG. 7 illustrates another screenshot for a report requesting approval or verification from a manager. As can be seen from FIG. 7, in this case the employee was tracked as being off-site for 30 minutes during the shift and that the shift was thus unverified. From the available options at the bottom of the screen, the manager can select a number of possible courses of action. The manager can use his or her judgment whether to approve (i.e. confirm) or reject (i.e. decline) the employee's request for partial payment. Additionally, the manager can modify the report to reduce the amount to be paid to the employee, verify the hours worked, adjust the pay rate or otherwise amend the report. As well, the manager may call the employee or the employer premises to confirm the data in the report.

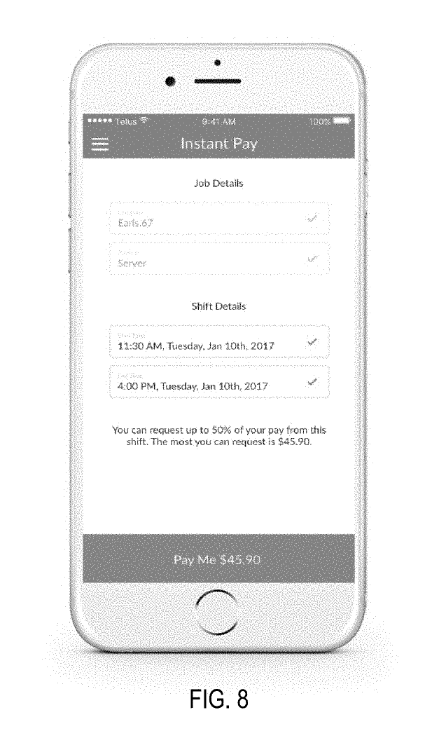

As noted above, the partial payment for a shift already worked by an employee may not be automatic. For the implementation where the employee has to manually request a partial payment for a specific shift, FIG. 8 illustrates a screen where the employee has to enter the details of the shift for which a partial payment is being requested. In this screen, the employee enters the start time of the shift, the end time of the shift, the job/position for the shift, and the identity of the manager or supervisor who is to approve the shift. It should be noted that a screen similar to this may also be used by the employee to report details regarding the shift for inclusion in the report. For clarity, the screen details the employer details as well as the details regarding the employer location. For employers with multiple locations, the application may allow the employee to change the employer location for each shift to ensure proper recordkeeping for each shift at each location.

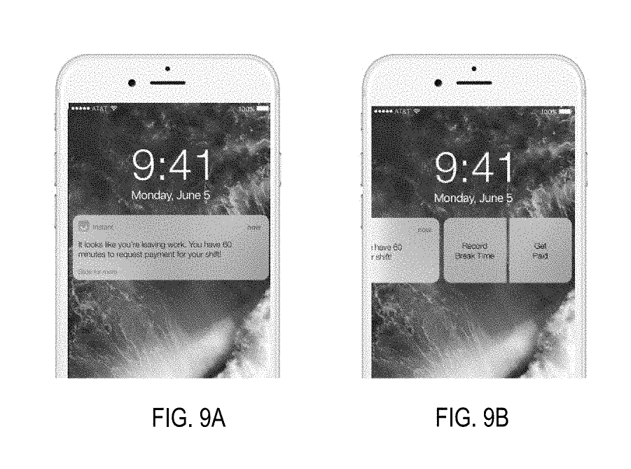

FIG. 9A-B details two screen shots for a time limited request for payment by an employee. As can be seen from the screenshot in FIG. 9A, once the employee has left the employer's premises at the end of the shift, the employee is prompted as to whether he or she would wish to request a partial payment. For this implementation, a 60 minute time window in which to request payment was configured. Options for requesting payment are available in the event the employee wants a partial payment as shown in FIG. 9B.

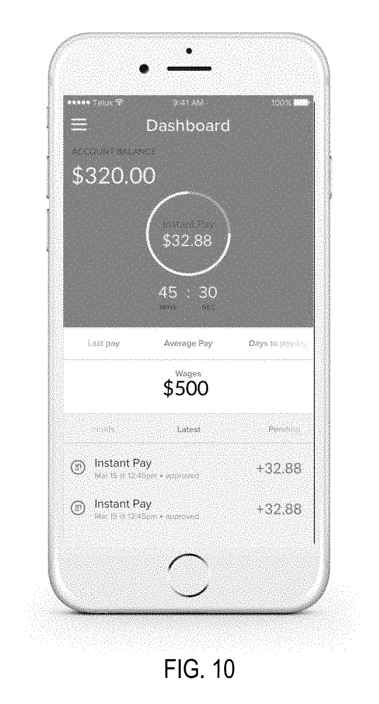

In the event the employee wants a partial payment and the system is not configured to automatically prompt the employee when the employee leaves the employer premises, the employee can launch the application and request payment. The screen in FIG. 10 shows not just the balance in the employee's account but also the time left in the window during which the employee can request partial payment for the immediately preceding shift.

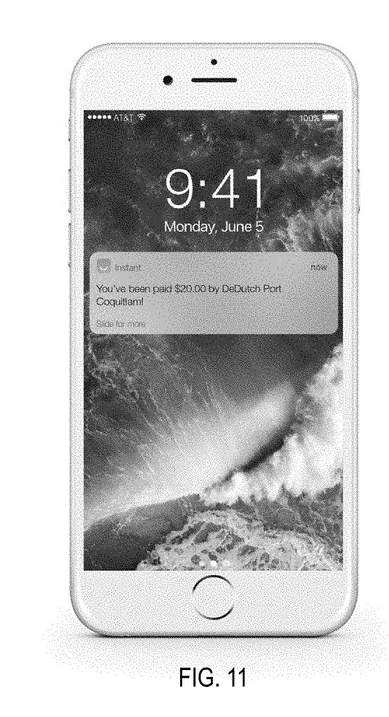

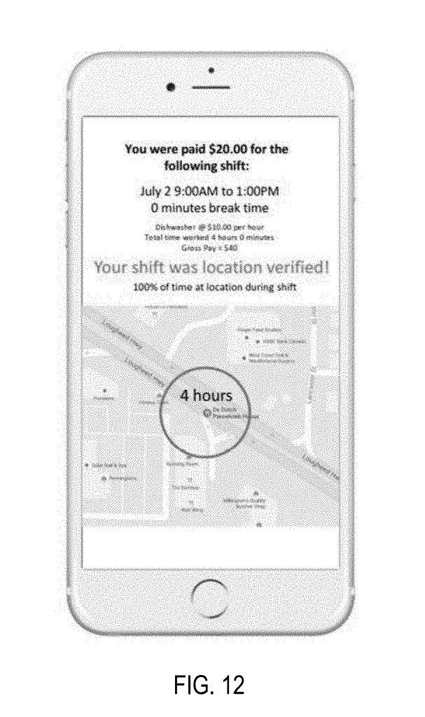

Once a manager approves an employee's request for partial payment, the employee is notified that the request has been granted and that the funds have been deposited into the employee's account and detailed on the second database. The notification may take the form of a message as shown in FIG. 11 and the report that the employee receives may take the form of the report detailed in FIG. 12. As can be seen from FIG. 12, the report details the data points regarding the partial payment (i.e. how much), the shift (time and duration of the shift along with how many breaks and for how long), the position for the shift, the rate of pay for that position, the length of the shift, the gross pay for the shift, how much time the employee spent off-site during the shift, and whether the employee's presence on the employer premises were verified during the shift.

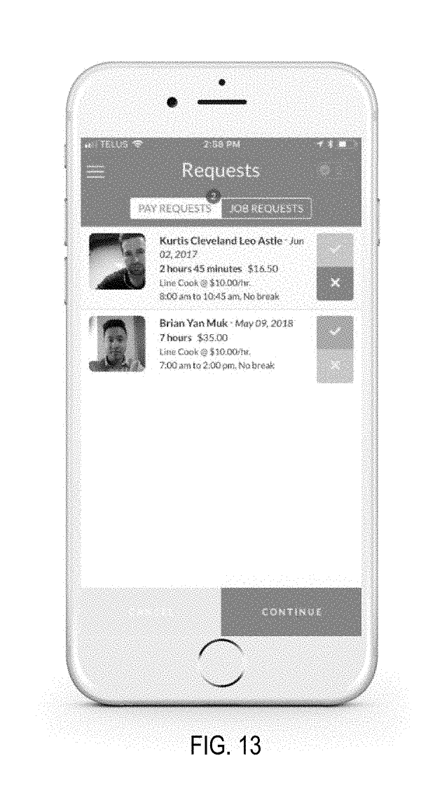

For the manager, he or she may receive multiple approval requests for multiple reports. While approving a single report for a single shift for a single employee is easy, having multiple reports to approve may be onerous. As such, managers may be given the option to forward some of the reports to other managers for approval or multiple reports may be approved using a single screen. Such a screen is illustrated in FIG. 13 where summaries of the various reports are presented. As can be seen, the location verified reports (i.e. the reports for shifts for which the employee was verified by his or her device as being on the employer's premises for the full length of the shift) are colored differently from the unverified reports. To approve a report from this screen, the manager merely has to click the proper button for the relevant report. Rejecting the relevant report is also simple as the manager merely has to click the proper button.

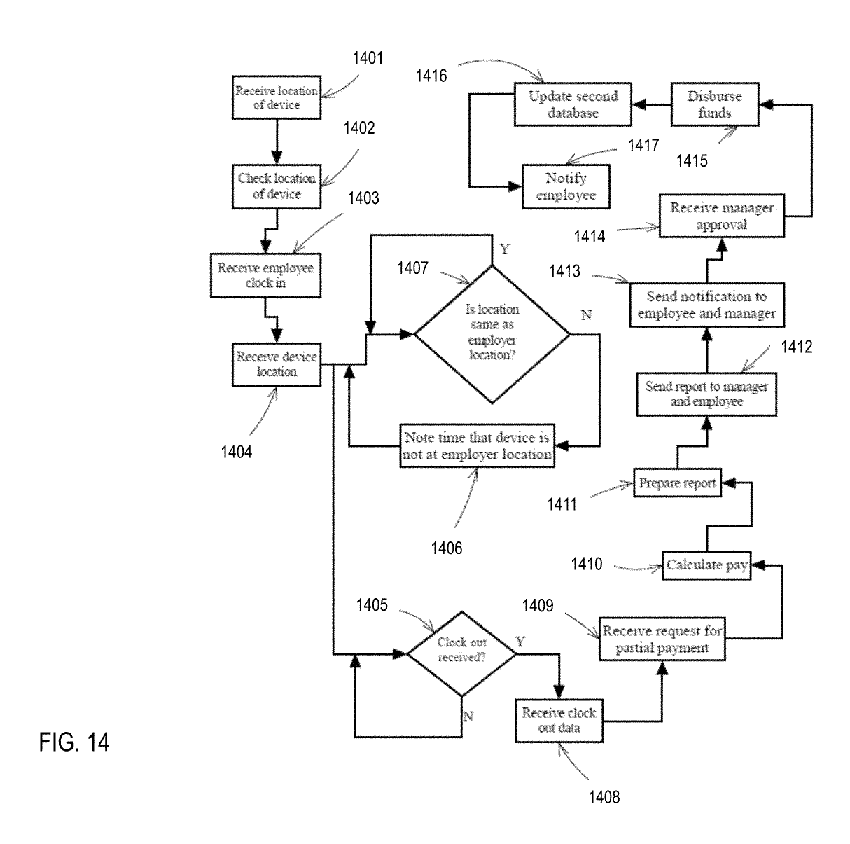

Referring to FIG. 14, a flowchart detailing a method according to one aspect of the invention is illustrated. For this method, a server determines an employee's pay for a specific shift and confirms that the employee has been at the employer's premises during the shift. Step 1401 has the server receiving data from an employee's device that the employee is at the employer's premises. This is done by having the employee device report the device's location in GPS coordinates. These coordinates are then checked (step 1402) against the stored GPS coordinates of the employer's premises along with a suitable radius value around those center coordinates. Once the device's GPS coordinates are within the specified radius of the employer's premises GPS coordinates, then the device (and hence the employee) is considered to be within the employer's premises. Step 1403 then has the server receiving data detailing that the employee has clocked in or has registered to start a shift at the employer's premises. Once the employee has started his shift, the device periodically sends updates to the server as to the device's location. Step 1404 is therefore for the server to periodically receive these location updates while step 1407 is to check the contents of these updates to determine if the location indicates that the device is still in the employer's premises. In step 1406, if the device is determined to be outside the employer's premises, the server notes when the employee is out of the employer's premises (ie off-site). As long as the location updates indicate that the device is off-site, the server notes these times. The method then loops back to step 1407. On the other hand, if the device is determined to be on-site (i.e. still in the employer's premises), the server returns to step 1407. At the same time that the server receives location updates from the employee's device, the server also checks (step 1405) if it has received data indicating that the employee has clocked out or has ended his shift. If the employee's clock out has been received, the server then receives (step 1408) the data regarding the employee's clock out (the clock out time, date, location, and length of time of the shift) and prepares a report. If the system allows for the employee to request a partial payment for the shift, the server may also receive this request from the employee (step 1409). The server then calculates (step 1410) the employee's pay along with a report for submission to a manager (step 1411) and then sends the report to the manager (step 1412). Notifications are then sent to both the employee and the manager (step 1413). Once the manager has approved the report and the request for partial payment, the server receives this approval (step 1414). The server then stores this report and disburses the partial payment to the employee by first notifying the second database that funds are to be deposited into the employee's account (step 1415). The second database is thus updated (step 1416) and a report or notification about the deposit is sent to the employee (step 1417).

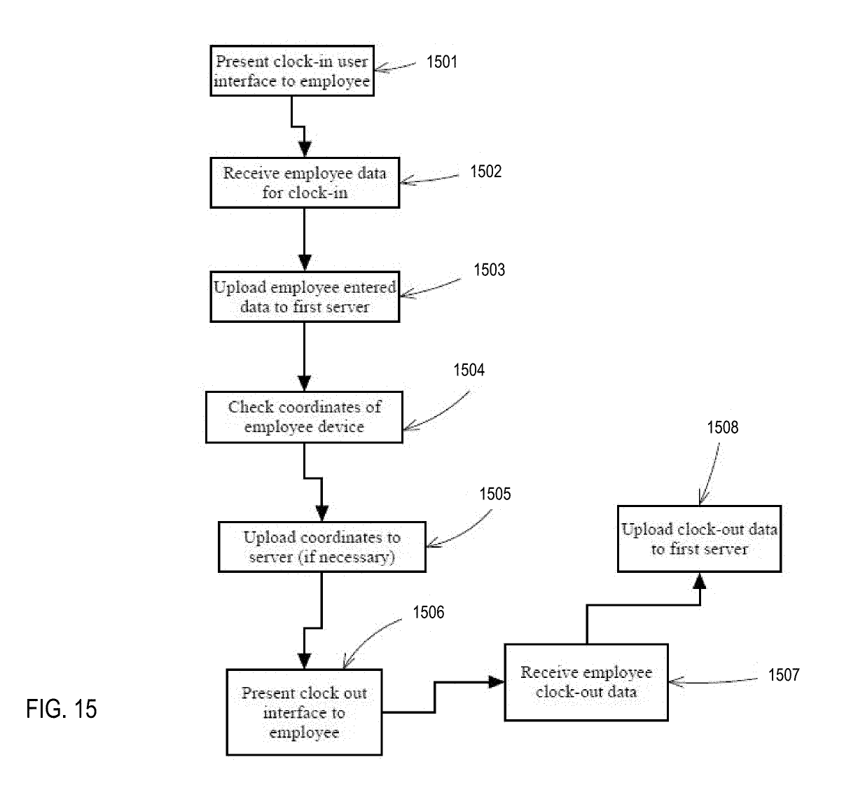

In another embodiment, the present invention provides a method for a mobile device to monitor an employee's location relative to an employer's premises. This method is outlined in the flowchart illustrated in FIG. 15. The method starts at step 1501, that of presenting a user interface screen to the employee prompting the employee to clock in or to register to start a work shift at a specific employer's premises. This prompt to clock in may be launched by the employee manually launching the app or application on his device or it may be triggered by the device detecting that the device's GPS coordinates indicate that the device is within a predetermined radius of an employer's premises. As noted above, this can be determined by the GPS coordinates of a location denoting the employer's premises and then assigning a suitable distance or radius from the center of those premises.

The employee can then sign in or clock in for his or her shift (step 1502) and the clock-in data can then be uploaded to the server (Step 1503). Once the employee has clocked in to start his or her shift, the device then periodically checks the GPS coordinates of its location (step 1504). These coordinates then be uploaded to the server (step 1505). It should be noted that the periodic GPS checks may be accomplished automatically every x minutes or it may be accomplished in response to a query from the server. Alternatively, the device may keep the results of these periodic checks internally and collate them into a log to be uploaded to the server. If kept and collated internally, the device may also check the results of these location updates to determine if the device is still within the employer's premises. If checked against the GPS coordinates of the employer's premises, the device may also indicate or note whenever the device is outside of these premises during the shift.

While the device is periodically checking the GPS coordinates of the device's location, the device may also be checking the time to determine if the employee's shift is over. This may be done in an implementation where the employee enters both the start and time of the shift as well as in an implementation where the employer sends a set schedule for the employee. An alarm may be set in the device such that when the alarm is activated (i.e. the shift is over), the device can launch a specific app and the employee is provided with another user interface prompt to clock out (step 1506). Conversely, the prompt to clock out may be presented to the employee when the employee manually launches the same app.

While the employee is clocking out or ending his shift, the employee enters data into the device (Step 1507). This data may include the date, time, length of shift, any breaks taken, length of the breaks, etc. Once entered, the data can then be uploaded by the device to the server (step 1508).

After the above steps, the device operates as a passive device where the server sends notifications to the employee. The device can thus receive notifications about the report being sent to the manager of the shift, about the approval of the report, and about the partial payment into the employee's account.

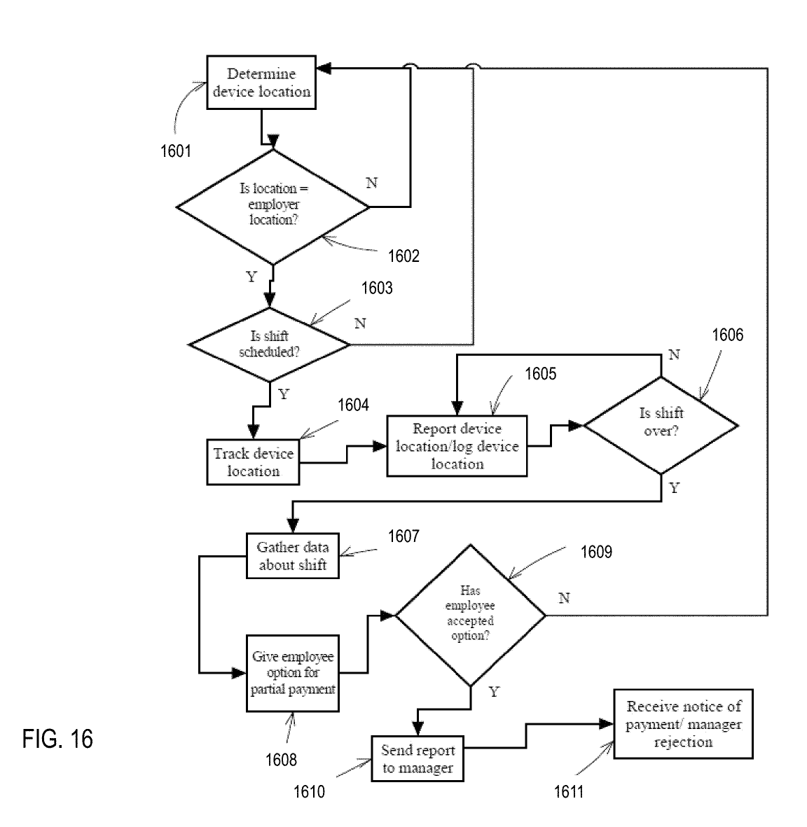

Referring to FIG. 16, a flowchart detailing the steps in another embodiment of the invention is illustrated. In this method, the employee user is not required to manually clock-in or clock-out as the device merely checks if the employee is at the employer location and if the employee is scheduled for a shift. If the employee is scheduled for a shift, the device starts tracking and reporting its location to the server.

In FIG. 16, the method beings with step 1601, that of determining the device's location. If the device location is determined (step 1602) to not be the same as the location for an employer premises, then the logic flow returns to step 1601. If, however, the device location is determined to be the same as an employer's premises, then step 1603 is executed. Step 1603 determines if the employee is scheduled for a work shift at that specific employer's premises. This can be done by retrieving a schedule for the employer and/or the employee for that specific employer's premises. If the employee is not scheduled for a work shift, then the logic flow returns to step 1601. Otherwise, the device's location is tracked or logged (step 1604). This step involves reporting the device's location to the server and/or logging the device's location (step 1605). The shift's duration is continuously tracked and the end of the shift is monitored (step 1606). If the shift is not yet over, then the device's location continues to be tracked and reported or logged. Once the employee's shift is over, the device then gathers data about the shift (step 1607). This may involve retrieving data from the server and/or prompting the employee user for data. Such data may include the rate of pay, the start and stop times for the shift, the employer identity, the employee identity, as well as other data points.

Once the device has gathered the data regarding the shift, the employee is provided with the option of requesting partial payment for the shift which has just concluded (step 1608). To this end, a prompt such as those illustrated in FIG. 9 or 10 may be presented to the employee. The employer may then accept the option through this prompt in step 1609. If the employee has not opted for a partial payment in step 1609, then the logic flow returns to step 1601. Otherwise, the report for the shift and the request for partial payment are sent to the shift's manager (step 1610). The device then waits for the manager's approval and notification that payment has been made or a rejection of the payment request (step 1611).

Preferably, the employee device used is GPS (Global Positioning System) enabled so that the device's location using coordinates can be determined. As well, the device preferably has access to the Internet so that data may be exchanged with the first server.

To assist the corporate entity providing the service to the employee and the employer, the entity may use a scheme that allows each employer to have either a specific amount of credit facilities with the corporate entity or to deposit a set amount of funds with the entity. Any partial payments made to the employer's employees are set off against these credit facilities or are withdrawn from the funds deposited by the employer. At the end of the regular pay period or cycle, the employer, instead of directly paying the employee, forwards the funds to the entity. The entity then replenishes the credit facilities or the funds deposited based on how much was sent to the employees as partial payment. The rest of the funds are then sent to the employees as the rest of their remuneration.

To better explain the above, an example is provided. For this example, employer A has a gross payroll of $10,000 every two weeks. After deductions and taxes, the net payroll is $7,500. For this example, the system is configured for partial payments of 50% of gross pay to employees. Accordingly, employer A deposits $5,000 with the corporate entity providing the system and the services associated with the system of the invention. During the two weeks of the pay period, assume that the entity paid out $3500 in partial payments to employees of employer A. At the end of the two week pay period, employer A processes its payroll regularly and, instead of directly paying its employees the net $7,500 payroll, employer A sends these payroll funds to the entity. The entity then takes the $3500 disbursed as partial payments to employer A's employees and replenishes the funds allocated to employer A's account. The rest of the $7500 received from employer A (i.e. the $4000 left after $3500 has been used to replenish the funds on employer A's accounts) are then disbursed to employer A's employees as the rest of their pay for the two week pay period. To further clarify the example, one can assume that employee B was entitled to a gross pay of $500 and a net pay of $400 for a specific two week period but had received partial payments of $250. Then, at the end of the same two week pay period, employer A sends the $400 net pay for employee B to the entity. The entity then takes $250 from the $400 to compensate for the $250 already disbursed and the rest of the net pay (i.e. $150) is disbursed or passed on to employee B. The $250 taken from the net pay is then used to replenish employer A's accounts with the entity.

It should be clear that the entity may charge employer A for the service provided to employer A and its employees.

It should also be clear that, as an alternative, instead of having the employer deposit a set amount with the entity, the entity may provide credit facilities for a set amount for the employer. The partial payments made to an employer's employees can then be made against such credit facilities and, as the employer sends the net pay of its employees to the entity, the entity can replenish/adjust the credit facilities accordingly.

From the above, it should be clear that, using the system and method of the invention, an employer can provide its employees with access to money already earned without having to amend and/or adjust its payroll cycle. An employer can thus continue processing its payroll and the only change to its payroll would be to send its payroll funds to the entity instead of directly to its employees.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for determining and remitting a worker's pay, the system comprising:
a first server for receiving data regarding a shift worked by the worker, the first server calculating the worker's remuneration based on a length of the shift for the worker;
a first database containing information for the worker including the worker's employment status with the at least one employer and the worker's rate of pay, the first database being accessed by the first server to retrieve information regarding the worker to thereby calculate the worker's pay;
a financial system where funds are available that enable the immediate payment of money to the worker;
wherein the first server disburses a partial payment to the worker from the financial system based on the worker's remuneration for the shift.

2. The system according to claim 1 wherein the first database may contain the worker's monthly or annual salary amount which can be used as the basis for the partial payment.

3. The system according to claim 1 wherein a user device associated with the worker is periodically queried by the server regarding a location of the user device during the shift, the data received by the server being in response to periodic queries from the server.

4. The system according to claim 3 wherein the user device automatically sends periodic updates regarding the user device's location to the server during the shift.

5. The system according to claim 3 wherein the server receives a log or report of the user device's reported time at a shift.

6. The system according to claim 1 wherein the partial payment is disbursed only after the at least one employer approves the report.

7. The system according to claim 1 wherein the partial payment is disbursed only after receipt of time and attendance records from an employer's system.

8. A system according to claim 7 wherein the employee's remuneration includes gratuities received by the employee during the shift.

9. The system according to claim 1, wherein the worker is an employee.

10. The system according to claim 1, wherein the worker is a contractor.

11. The system according to claim 1 further including:
a finance related device for the worker,
a second database containing finance information for the worker, including a balance for at least one account for the worker, the balance for the at least one account for the worker being increased based on the partial payment disbursed by the first server;
a second server for communicating with at least one server interacting with the finance related device of the worker, the finance related device being used by the worker to access funds detailed by the balance on the at least one account, the second server being in communication with the second database to increase or decrease the balance based on communications with the at least one server interacting with the finance related device.

12. The system according to claim 11 wherein the finance related device is at least one of a credit card, a debit card, or a prepaid card.

13. The system according to claim 1 wherein the worker uses the user device to declare the duration of the shift.

14. The system according to claim 1 wherein the worker starts and ends the shift by using an employer's electronic time tracking system.

15. A system according to claim 1 wherein the server sends a notification to a manager of the worker when a shift has been declared.

16. The system according to claim 1 wherein the server sends a notification to the worker when the partial payment has been disbursed.

17. A method for determining and remitting a worker's pay, wherein a first database contains information for the worker including the worker's employment status with the at least employer and the worker's rate of pay, the method comprising the steps of:
receiving data regarding a length of a shift worked by the worker,
retrieving from the first database the employment status of the worker and the worker's rate of pay,
calculating the worker's remuneration based on a length of the shift for the worker, as well as the employment status of the worker and the worker's rate of pay, and
disbursing a partial payment to the worker from a financial system based on the worker's remuneration for the shift.

18. The method of claim 17, further comprising the step of receiving a location associated with a user device associated with the worker.

19. The method of claim 17, wherein the partial payment is disbursed only after receipt of time and attendance records from an employer's system.

20. The method of claim 17, wherein the worker is an employee.

21. The method of claim 17, wherein the worker is a contractor.

22. The method of claim 17, further including:
increasing a balance for at least one account for the worker stored in a second database, based on the disbursed partial payment, and
in response to a finance related device being used by the worker to access funds detailed by the balance on the at least one account, increasing or decreasing the balance of the at least one account accordingly.

23. The method of claim 17, wherein the finance related device is at least one of a credit card, a debit card or a prepaid card.

24. The method of claim 17, wherein the worker uses a user device to declare the duration of the shift.

25. The method of claim 17, wherein the worker starts and ends the shift by using an employer's electronic time tracking system.

26. The method of claim 17, further comprising sending a notification to a manager of the worker when a shift has been declared,

27. The method of claim 17, further comprising sending a notification to the worker when the partial payment has been disbursed.

28. A non-transitory computer readable medium with computer executable instructions embodied thereon for determining and remitting a worker's pay, the computer executable instructions causing a computer to perform the process of:
receiving data regarding a length of a shift worked by the worker,
retrieving from the first database the employment status of the worker and the worker's rate of pay,
calculating the worker's remuneration based on a length of the shift for the worker, as well as the employment status of the worker and the worker's rate of pay, and
disbursing a partial payment to the worker from a financial system based on the worker's remuneration for the shift.
